(19) United States
(12) Patent Application Publication
(10) Pub. No.: US 2009/0310601 A1
(43) Pub. Date: Dec. 17, 2009

(54) COMMUNICATION CONTROL DEVICE, COMMUNICATION TERMINAL DEVICE, COMMUNICATION SYSTEM, AND COMMUNICATION CONTROL METHOD

(76) Inventor: Satoshi Kawahata, Kanagawa (JP)

Correspondence Address: FROMMER LAWRENCE & HAUG LLP, 745 FIFTH AVENUE, NEW YORK, NY, 10151, US

(21) Appl. No.: 12/482,514

(22) Filed: Jun. 11, 2009

(30) Foreign Application Priority Data
Jun. 12, 2008 (JP) P2008-153784

(51) Int. Cl. H04L 12/66

(52) U.S. Cl. 370/352

(57) ABSTRACT

A communication control device includes: a network communication unit connected to plural communication terminal devices via a network that enables communication in a booked band for communication with the plural communication terminal devices; and a control unit that, when a connection request is made from the communication terminal device but the band is not assignable, changes the band with the communication terminal device during communication to secure the band for communication with the communication terminal device that has made the connection request.

### BACKGROUND OF THE INVENTION

1. Field of the Invention

The present invention relates to a communication control device, a communication terminal device, a communication system, and a communication control method. Specifically, the invention enables efficient multipoint connection using a guaranteed network that enables communication in a booked band, for example.

2. Description of the Related Art

Recently, the next generation network (NGN) has been constructed by replacing the circuit switched telephone network in the past with a network based on IP (Internet Protocol Technology).

The NGN network is an IP network itself having the band compensation function and security function and using a session initiation protocol (SIP) for integrated realization of telephone service, video communication service, data communication service, etc.

Further, the NGN network is a guaranteed network that enables communication using a booked band with guaranteed QoS (Quality of Service), and stable real-time communication such as sound communication and video delivery without disconnection or delay of sound and video. Further, in the NGN network, communications via connection of plural points are easy.

Here, in the case of communications via connection of plural points, switching of communication lines and complex settings are necessary, and an MCU (multipoint control unit) is generally used for efficiently connecting and controlling plural communication terminal devices. The MCU connects three or more points at the same time for aggregation and delivery of video and sound by switching, mixing, or the like of video and sound.

When a teleconference is held through communications via connection of plural points, a complicated procedure is necessary such that the organizer should book the conference service in advance and participants make phone calls to MCU at the appointed time and date and enter the book ID and the like for attending the conference. Accordingly, in JP-A-2005-109922, a teleconference booking system and teleconference booking method that enables automatic user operation at connection of the teleconference, e.g., the dial operation to the predetermined number and simplification of user operation by transmitting conference information necessary for connecting operation to the conference terminal and the multipoint control unit are provided. Further, in JP-A-2005-5991, multipoint-call is enabled by calling the third person without a booking while maintaining the calling state between two.

### SUMMARY OF THE INVENTION

In the case of multipoint connection in the guaranteed network, bands for connection to the respective points are set in advance by dividing available bands by the number of points. Accordingly, even when a communication channel is available, it may be impossible to make communication because the communication is restricted to the preset band, or image quality may be deteriorated in video communication because the communication is restricted to the preset band. Further, when the entire available bands are assigned, even when a communication channel is available, it may be impossible to make communication using the available communication channel.

FIG. 6 is a sequence diagram for the case where communication using an available channel is disabled. A multipoint control unit 60 sends an INVITE message to a communication terminal device 50A as a destination (step ST101) to establish a session with the communication terminal device 50A as a participant of an electronic conference, for example. Here, when the booked band of the NGN network 40 is 15 Mbps, for example, and communication is made only between the multipoint control unit 60 and the communication terminal device 50A, the multipoint control unit 60 describes the booked band, i.e., 15 Mbps in band information of the INVITE message for effective utilization of the band.

The NGN network 40 transfers the INVITE message supplied from the multipoint control unit 60 to the communication terminal device 50A (step ST102).

The communication terminal device 50A sends a 200 OK message as a response when the device can accept the received INVITE message (step ST103). Further, the communication terminal device 50A accepts the received INVITE message and makes settings to enable communication in the band of 15 Mbps.

The NGN network 40 transfers the 200 OK message supplied from the communication terminal device 50A to the multipoint control unit 60 (step ST104).

The multipoint control unit 60 establishes a session with the communication terminal device 50A in response to the supply of the 200 OK message from the communication terminal device 50A, and makes communication with the communication terminal device 50A using the booked band of 15 Mbps (step ST105).

Then, when a new participant attends the electronic conference using a communication terminal device 50B, the communication terminal device 50B sends an INVITE message to the multipoint control unit 60 as a destination (step ST106). The unit describes the booked band, i.e., 15 Mbps in band information of the INVITE message.

The NGN network 40 assigns the entire booked band for the communication between the multipoint control unit 60 and the communication terminal device 50A, and sends a response message that the request is not acceptable, for example, a 488 Not Acceptable Here message as a response to the INVITE message from the communication terminal device 50B (step ST107).

Accordingly, even when a communication channel is available, the entire booked band is used and the participation in the conference from the communication terminal device 50B is disabled.

Further, when the bands are assigned for the communication with the respective participants in advance regardless whether a participant is attending the conference or not, it may not be impossible to make communication using an available channel. However, the bands are assigned to the participants who are not attending the conference, the booked band is not effectively utilized.

FIG. 7 is a sequence diagram for the case where bands are assigned for communication with the respective participants in advance. When the booked band of the NGN network 40 is 15 Mbps and two communication terminal devices 50A and 50B are used in an electronic conference, for example, the multipoint control unit 60 respectively assigns bands of 7.5 Mbps for communication between the multipoint control unit 60 and the communication terminal device 50A and the communication between the multipoint control unit 60 and the communication terminal device 50B. Here, the multipoint control unit 60 sends an INVITE message to the communication terminal device 50A as a destination (step ST111) to establish a session with the communication terminal device 50A for holding an electronic conference. Here, the band of 7.5 Mbps is assigned for the communication between the multipoint control unit 60 and the communication terminal device 50A, and the unit describes the assigned band, i.e., 7.5 Mbps in band information of the INVITE message.

The NGN network 40 transfers the INVITE message supplied from the multipoint control unit 60 to the communication terminal device 50A (step ST112).

The communication terminal device 50A sends a 200 OK message as a response when the device can accept the received INVITE message (step ST113). Further, the communication terminal device 50A accepts the received INVITE message and makes settings to enable communication in the band of 7.5 Mbps.

The NGN network 40 transfers the 200 OK message supplied from the communication terminal device 50A to the multipoint control unit (step ST114).

The multipoint control unit 60 establishes a session with the communication terminal device 50A in response to the supply of the 200 OK message from the communication terminal device 50A, and makes communication with the communication terminal device 50A using the band of 7.5 Mbps (step ST115).

Then, when a new participant attends the electronic conference using the communication terminal device 50B, the communication terminal device 50B sends an INVITE message to the multipoint control unit 60 as a destination (step ST116). The unit describes the assigned band, i.e., 7.5 Mbps in band information of the INVITE message.

The NGN network 40 transfers the INVITE message supplied from the communication terminal device 50B to the multipoint control unit 60 (step ST117).

The multipoint control unit 60 determines whether the received INVITE message is acceptable or not. Here, the band assigned to the communication terminal device 50B is described in the band information of the received INVITE message, and the unit sends a 200 OK message as a response to accept the received INVITE message (step ST118).

The NGN network 40 transfers the 200 OK message supplied from the multipoint control unit to the communication terminal device 50B (step ST119).

The communication terminal device 50B establishes a session with the multipoint control unit 60 in response to the supply of the 200 OK message from the multipoint control unit 60, and makes communication with the multipoint control unit 60 using the band of 7.5 Mbps (step ST120).

In this manner, when participants increase during the conference, communication can be made with the added participants. However, when the participants are not attending the conference, the bands assigned to the not participating participants are not in use, and the booked band is not effectively utilized.

Accordingly, in embodiments of the invention, a communication control device, a communication terminal device, a communication system, and a communication control method that enable multipoint communication effectively using a booked band are provided.

A concept of the invention is to assign a booked band to the channel during communication when communication is made using a network that enables communication in the booked band, and provide an available band by reducing the band of the channel during communication when a connection request is made from another person when there is an available channel. Further, the concept is to enable communication with the other person who has made the connection request in the communication channel by assigning the available band to the available channel.

A communication control device according to an embodiment of the invention includes a network communication unit connected to plural communication terminal devices via a network that enables communication in a booked band for communication with the plural communication terminal devices and a control unit that, when a connection request is made from the communication terminal device but the band is not assignable, changes the band with the communication terminal device during communication to secure the band for communication with the communication terminal device that has made the connection request.

Further, a communication terminal device according to an embodiment of the invention includes a network communication unit connected to a communication control device via a network that enables communication in a booked band for communication with the communication control device, and a control unit that, when a response that a request is not acceptable is issued to the connection request to the communication control device, makes a connection request to the communication control device using a transmission path of a narrower band than that in the network.

Furthermore, a communication system according to an embodiment of the invention includes a communication control device, and plural communication terminal devices connected to the communication control device via a network that enables communication in a booked band, wherein the communication control device includes a network communication unit that makes communication with the plural communication terminal devices via the network, and a control unit that, when a connection request is made from the communication terminal device but the band is not assignable, changes the band with the communication terminal device during communication to secure the band for communication with the communication terminal device that has made the connection request, and the communication terminal device includes a network communication unit that makes communication with the communication control device via the network, and a control unit that makes a connection request to the communication control device, and when a negative response is issued to the connection request, then makes communication with the communication control device using the secured band.

In addition, a communication control method according to an embodiment of the invention includes the steps of making communication with a communication terminal device connected via a network that enables communication in a booked band, and when a connection request is made from another communication terminal device but the band is not assignable, changing the band with the communication terminal device during communication to secure the band for communication with the communication terminal device that has made the connection request.

In the embodiments of the invention, the communication control device and the plural communication terminal devices can be connected via the network that enables communication in a booked band. The communication control device assigns the booked band for the channel during communication, for example. When a connection request is made from another communication terminal device when there is an available communication channel, that is, the band is not assignable to the connection request, the device reduces the band with the communication terminal device during communication and secures the band for communication with the communication terminal device that has made the connection request. The communication control device secures the band, and then, sends a connection request containing information indicating the secured band to the communication terminal device that has made the connection request. Alternatively, the device sends a response indicating that the request is not acceptable containing information indicating the secured band to the connection request.

The communication terminal device makes a connection request to the communication control device, and when a response indicating that the connection request is not acceptable is issued, makes a connection request to the communication control device using a transmission path of a narrower band than that in a network that enables communication in a booked band. Further, when the response indicating that the connection request is not acceptable contains the information indicating the secured band, the communication terminal device sends a connection request for communication in the secured band to the communication control device. Furthermore, when the connection request containing the information indicating the secured band is made from the communication control device, the communication terminal device supplies a response indicating the connection request is acceptable to the communication control device.

According to the embodiments of the invention, when the band is not assignable when the connection request is made from the communication terminal device, the communication control device changes the band with the communication terminal device during communication and secures the band for communication with the communication terminal device that has made the connection request. Accordingly, even when the booked band is assigned to the channel during communication, when a connection request is made from another communication terminal device in an available channel, the band is assigned to this channel and communication with the other communication terminal device that has made the connection request is enabled and the booked band can be effectively utilized for multipoint communication.

### BRIEF DESCRIPTION OF THE DRAWINGS

FIG. 1 shows a configuration of a communication system.

FIG. 2 shows a configuration example of a communication terminal device.

FIG. 3 shows a configuration example of a multipoint control unit.

FIG. 4 is a sequence diagram for the case of holding an electronic conference.

FIG. 5 is a sequence diagram for the case where a request of a session for communication over a booked band is supplied to the multipoint control unit.

FIG. 6 shows a sequence diagram for the case where communication using an available channel is disabled.

FIG. 7 is a sequence diagram for the case where bands are assigned for communication with the respective participants in advance.

### DESCRIPTION OF PREFERRED EMBODIMENTS

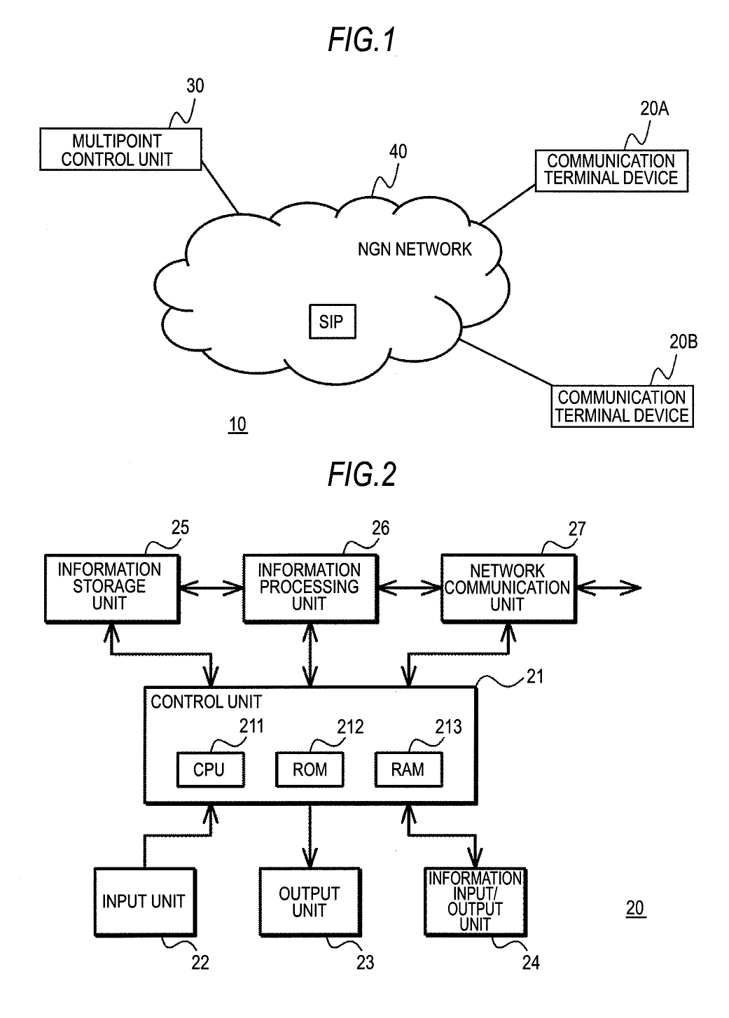

Hereinafter, one embodiment of the invention will be explained with reference to the drawings. FIG. 1 shows a configuration example of a communication system 10. In the communication system 10, plural communication terminal devices, for example, a communication terminal device 20A and a communication terminal device 20B and a multipoint control unit 30 are connected via a next generation network (NGN) 40 configured using an SIP (Session Initiation Protocol) server.

FIG. 2 shows a configuration example of the communication terminal device 20 (20A, 20B). The communication terminal device 20 has a control unit 21, an input unit 22, an output unit 23, an information input/output unit 24, an information storage unit 25, an information processing unit 26, and a network communication unit 27.

The control unit 21 controls the operation of the respective units of the communication terminal device 20. The control unit 21 includes a CPU (Central Processing Unit) 211, a ROM (Read Only Memory) 212, and a RAM (Random Access Memory) 213. In the control unit 21, the CPU 211 performs various kinds of control processing by loading and executing programs stored in the ROM 212 into the RAM 213, for example. For instance, a connection request to the multipoint control unit 30 and a response that the connection request is not acceptable are made, the control unit 21 uses a transmission path with a narrower band than in the network that enables communication in the booked band to make a connection request to the multipoint control unit 30. Further, when the response that the connection request is not acceptable contains information indicating the secured band, the control unit 21 sends a communication request for communication in the secured band to the multipoint control unit 30. Furthermore, when the connection request containing the information indicating the secured band is supplied from the multipoint control unit 30, the control unit performs processing of sending the response that the connection request is acceptable to the multipoint control unit 30.

The input unit 22 includes a keyboard, mouse, camera, microphone, etc. The output unit 23 includes a display, speaker, etc. The information input/output unit 24 includes a drive for a removable media such as a magnetic disk, optical disk, magneto-optical disk, or memory card, various kinds of input and output terminals, etc.

The information storage unit 25 includes an HDD (Hard Disk Drive), nonvolatile memory, etc. In the information storage unit 25, various kinds of information such as video signals, sound signals, and data input from the above described information input/output unit 24, or various kinds of information such as video signals, sound signals, and data sent from the other communication terminal device are stored and held.

The information processing unit 26 performs compression processing/decompression processing and packet processing/depacket processing. That is, the information processing unit 26 performs compression processing on the video signals and sound signals supplied from the input unit 22 and the transmission information loaded from the information storage unit 25 to generate compressed data. Further, the information processing unit 26 performs packet processing on the compressed data and multiplexes the compressed data by packetization to generate a transmission media stream. Furthermore, the information processing unit 26 performs depacket processing on a reception media stream received by the network communication unit 27 to obtain compressed data of video and sound. In addition, the information processing unit 26 performs decompression processing on the compressed data to generate the video signals and sound signals as reception information.

The network communication unit 27 establishes a session with the other communication terminal device via the NGN network 40 and makes communication. The network communication unit 27 transmits the transmission media stream generated by the information processing unit 26 to the other communication terminal device and supplies the reception media stream received by the other communication terminal device to the information processing unit 26.

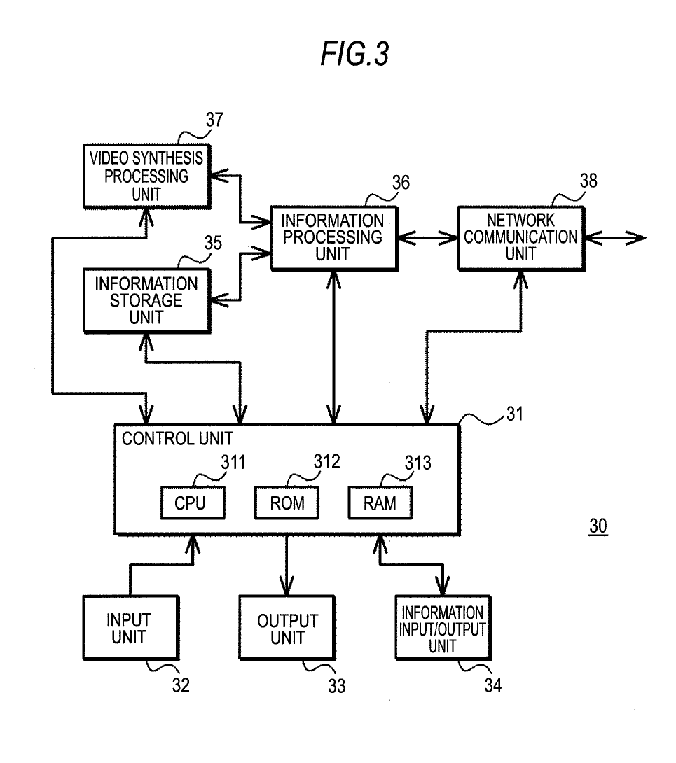

FIG. 3 shows a configuration example of the multipoint control unit. The multipoint control unit 30 has a control part 31, an input part 32, an output part 33, an information input/output part 34, an information storage part 35, an information processing part 36, a video synthesis processing part 37, and a network communication part 38.

The control part 31 includes a CPU (Central Processing Unit) 311, a ROM (Read Only Memory) 312, and a RAM (Random Access Memory) 313. In the control part 31, the CPU 311 controls the operation of the respective parts of the multipoint control unit 30 by loading and executing programs stored in the ROM 312 into the RAM 313, for example, to control transmission and reception of video signals and sound signals etc. Further, the control part 31 performs processing of loading video signals and sound signals sent from the communication terminal devices 20 at plural points and delivering the video signals and sound signals to the other communication terminal devices 20. Furthermore, when a connection request is made from the communication terminal device and no band is assignable, the control part 31 performs processing of changing the band with the communication terminal device during communication and securing a band for communication with the communication terminal device that has made the connection request. The control part 31 has a conference control function of processing of display of a list of conferences and the number of participants, participant information containing names, numbers, IP addresses, video codec and sound codec in use, and times of participation of participants, creation of new conferences and assignment of conference passwords, addition and delete of conference participants, settings of bands, ending of conferences, etc.

The input part 32 includes a keyboard, mouse, camera, microphone, etc. The output part 33 includes a display, speaker, etc. The information input/output part 34 includes a drive for a removable media such as a magnetic disk, optical disk, magneto-optical disk, or memory card, various kinds of input and output terminals, etc.

The information storage part 35 includes an HDD (Hard Disk Drive), nonvolatile memory, etc. In the information storage part 35, various kinds of information such as video signals, sound signals, and data input from the above described information input/output part 34, or various kinds of information such as video signals, sound signals, and data sent from the other communication terminal device 20 are stored and held.

The information processing part 36 performs compression processing/decompression processing and packet processing/depacket processing. That is, the information processing part 36 performs compression processing on the video signals and sound signals supplied from the input part 32, the transmission information loaded from the information storage part 35, and video signals generated by the video synthesis processing part, which will be described later, to generate compressed data. Further, the information processing part 36 performs packet processing on the compressed data and multiplexes the compressed data by packetization to generate a transmission media stream. Furthermore, the information processing part 36 performs depacket processing on a reception media stream received by the network communication part 38 to obtain compressed data of video and sound. In addition, the information processing part 36 performs decompression processing on the compressed data to generate the video signals and sound signals as reception information with respect to each communication terminal device, and supplies the video signals and sound signals to the output part 33 and the information storage part 35 and supplies the video signals to the video synthesis processing part 37.

The video synthesis processing part 37 performs synthesis processing of the video signals sent from the respective communication terminal devices 20 and the video signals supplied from the input part 32, and generates video signals of the synthesized videos representing the videos of the respective participants and supplies the signals to the information processing part 36.

The network communication part 38 is for making communication with plural communication terminal devices via the NGN network 40. The network communication part 38 sends the transmission media stream generated by the information processing part 36 to the communication terminal devices 20 of the conference participants and supplies the reception media stream supplied from the communication terminal devices 20 of the conference participants to the information processing part 36.

In the communication system 10 configured as described above, call control is performed using SIP protocols. In the SIP, when certain processing is performed, communications of a request message for requesting the processing and a response message as a response to the request message are performed.

The SIP message includes a start line, a header, and a body. The start line describes information indicating the purpose of the message. When the SIP message is a request message, the name of method, INVITE, BYE, UPDATE, ACK etc. are described in the start line. Here, INVITE is a request for session start (connection request). BYE is ending of the session. UPDATE is provision of updated session, and ACK is confirmation of reception of the final response. Further, when the SIP message is a response message, the status code of 200 OK, 488 Not Acceptable Here, or the like expressed by a three-digit number like an HTTP (Hypertext Transfer Protocol) is described in the start line. Here, 200 OK indicates the successful request. Further, 488 Not Acceptable Here indicates that the request is not acceptable.

The header describes the control details of the message, and includes plural header lines having prescribed meanings (e.g., From, To, Call-ID, or the like).

The body describes attachment information of the message. For example, in the INVITE message, identification of the session and information designating the type of the media used in the session are described according to an SDP (Session Description Protocol).

The NGN network 40 to which the plural communication terminal devices and the multipoint control unit are connected is a network provided by a telecommunications carrier, and enables communications with guaranteed quality and functions under the control of the telecommunications carrier. The architecture of the NGN network 40 is a two-stratum model of a transport stratum that provides the transfer function of packets and a service stratum that provides value-added service.

The transport stratum has a transport function of performing data transfer, a network attachment control function of receiving users, a resource reception control function of executing Qos control, etc. The NGN network 40 ensures the quality with respect to each media stream of allowed user by the network attachment control function and the resource reception control function. For example, the NGN network 40 enables communication in the booked band according to the agreement between the user and the telecommunications carrier providing the NGN network.

The service stratum has IP multimedia subsystem (IMS), a service control function of performing telephone emulation, an application support function, a service support function, etc.

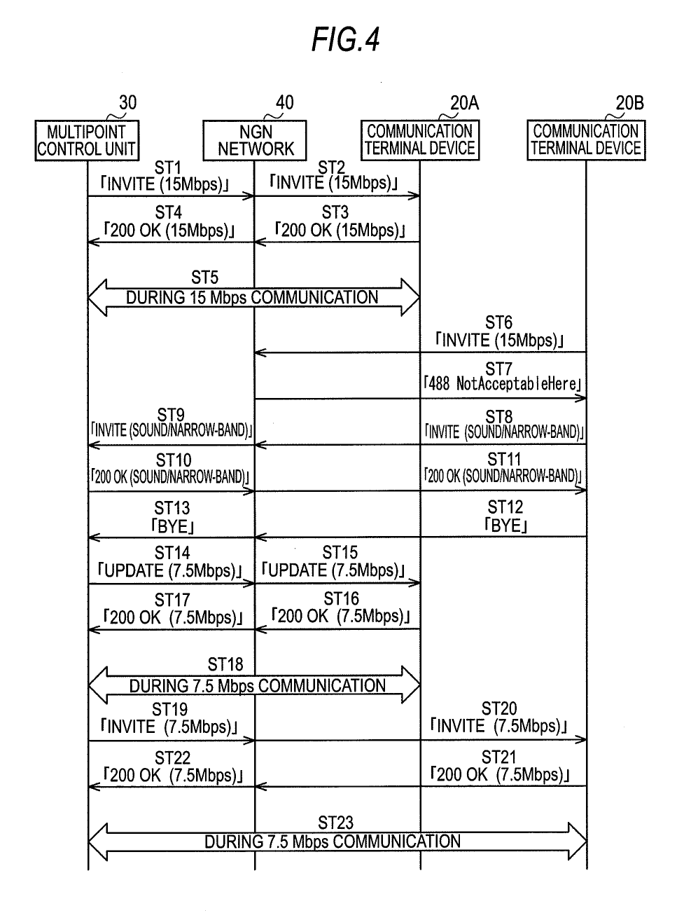

Next, a communication example of the communication system 10, for example, an operation of holding an electronic conference will be described using a sequence diagram in FIG. 4. In FIG. 4, the NGN network 40 makes broadband line in which communication of video signals and sound signals can be made and a line having a narrower band than that of the line available. Further, the case where, when a request of a session for communication over the booked band is made, the NGN network 40 responses a response message that the request is not acceptable will be explained.

In order to establish a session with a communication terminal device 20A of a participant of an electronic conference and hold the electronic conference, for example, the multipoint control unit 30 sends an INVITE message to the communication terminal device 20A as a destination (step ST1). Here, when the booked band of the NGN network 40 is 15 Mbps, for example, and communication is made only between the multipoint control unit 30 and the communication terminal device 20A, the multipoint control unit 30 describes the booked band, i.e., 15 Mbps in band information of the INVITE message for effective utilization of the band.

The NGN network 40 transfers the INVITE message supplied from the multipoint control unit 30 to the communication terminal device 20A (step ST2).

The communication terminal device 20A sends a 200 OK message as a response when the device can accept the received INVITE message (step ST3). Further, the communication terminal device 20A accepts the received INVITE message and stores the IP address of the multipoint control unit 30, the media type, the port number, the band information, etc. of video and sound and data contained in the INVITE message in a storage area provided for the multipoint control unit 30. When the INVITE message is not acceptable, the communication terminal device 20A sends a 488 Not Acceptable Here message as a response, for example.

The NGN network 40 transfers the 200 OK message supplied from the communication terminal device 20A to the multipoint control unit 30 (step ST4).

The multipoint control unit 30 sends an ACK message indicating reception of the response message to the communication terminal device 20A when the response message to the request message is supplied from the communication terminal device 20A.

In this manner, the multipoint control unit 30 can recognize establishment of a session when the 200 OK message from the communication terminal device 20A is transferred to the multipoint control unit 30. Further, the communication terminal device 20A can recognize establishment of the session when the multipoint control unit 30 supplies the ACK message to the communication terminal device 20A. For ease of explanation, in FIG. 4, the following explanation, and the drawings described as below, description and explanation of the ACK message will be omitted.

The multipoint control unit 30 establishes a session with the communication terminal device 20A in response to the supply of the 200 OK message from the communication terminal device 20A, and makes communication with the communication terminal device 20A using the booked band of 15 Mbps (step ST5).

Accordingly, the booked band of the NGN network 40 can be effectively utilized in the electronic conference and communication of video and sound can be performed between the communication terminal device 20A and the multipoint control unit 30.

Next, the case where participation in the electronic conference is added when the session is established and communication is made between the communication terminal device 20A and the multipoint control unit 30 will be explained.

When a new participant attends the electronic conference using the communication terminal device 20B, the communication terminal device 20B sends an INVITE message to the multipoint control unit 30 as a destination (step ST6). The unit describes the booked band, i.e., 15 Mbps in band information of the INVITE message when the booked band in the NGN network 40 is notified to the communication terminal device 20B.

The SIP server of the NGN network 40 determines whether the INVITE message from the communication terminal device 20B is acceptable or not. The SIP server transfers the INVITE message to the multipoint control unit 30 when the booked band is available and the band described in the band information of the INVITE message can be assigned. Further, the SIP server sends a response message that the request is not acceptable, for example, a 488 Not Acceptable Here message as a response when the booked band is not available or the band described in the band information of the INVITE message is not assignable.

Here, after processing from step ST1 to ST5 is performed, the booked band is not available, and the SIP server sends a 488 Not Acceptable Here message as a response (step ST7).

The communication terminal device 20B uses a narrow band line to notify the multipoint control unit 30 of the request for participation in the conference from the communication terminal device 20B, because the device is unable to make communication using a broadband line. Here, not only the INVITE message but the unique number of the communication terminal device 20 (e.g., the phone number, IP address, or the like) may be notified because it is necessary that the multipoint control unit 30 can determine that the request for the participation in the conference has been made by the communication terminal device 20B. In this manner, when the unique number is sent, the multipoint control unit 30 determines whether the notified unique number is the unique number of the participant or not, and, when the number is identical to the unique number of the participant, can determine that the request for participation in the conference has been made. Further, sound signal or the like for requesting for participation in the conference may be sent from the communication terminal device 20 to the multipoint control unit 30.

In order to notify the multipoint control unit 30 of the request for participation in the conference, the communication terminal device 20B sends an INVITE message to the multipoint control unit 30 as a destination using a narrow-band line, for example, a line used only for sound communication (step ST8).

The NGN network 40 transfers the INVITE message supplied using the narrow-band line to the multipoint control unit 30 (step ST9).

When the INVITE message is supplied from the communication terminal device 20B via the NGN network 40 to the multipoint control unit 30, the multipoint control unit 30 determines whether the transmission source of the INVITE message is allowed to participate in the conference or not. Here, when the multipoint control unit 30 determines that the communication terminal device 20B is the communication terminal device of the participant allowed to participate in the conference, the unit sends a response message indicating that the INVITE message is acceptable, i.e., a 200 OK message as a response (step ST10). Further, when the multipoint control unit 30 determines that the communication terminal device 20B is not the communication terminal device of the participant allowed to participate in the conference, the unit sends a response message indicating that the INVITE message is not acceptable to the communication terminal device 20B.

The NGN network 40 transfers the 200 OK message supplied from the multipoint control unit 30 using the narrow-band line to the communication terminal device 20B (step ST11).

The communication terminal device 20B determines that the request for participation in the conference has been transmitted to the multipoint control unit 30 when the 200 OK message is supplied from the multipoint control unit 30. Further, in the electronic conference, the narrow-band line is not used, and a BYE message indicating ending of the session is sent to the multipoint control unit 30 as a destination (step ST12).

The NGN network 40 transfers the BYE message supplied from the communication terminal device 20B using the narrow-band line to the multipoint control unit 30 (step ST13).

The multipoint control unit 30 ends the session with the communication terminal device 20B in response to the supply of the BYE message from the communication terminal device 20B via the NGN network 40.

Through the processing, even when the entire booked band is assigned to the communication between the multipoint control unit 30 and the communication terminal device 20A, the multipoint control unit 30 can determine that the communication terminal device 20B has participated in the electronic conference.

As the participants in the electronic conference increases, the multipoint control unit 30 performs processing of reducing the band assigned to the communication between the multipoint control unit 30 and the communication terminal device 20A and assigning the reduced part of the band to the communication between the multipoint control unit 30 and the communication terminal device 20B.

In order to reduce the band assigned to the communication between the multipoint control unit 30 and the communication terminal device 20A, the multipoint control unit 30 generates an UPDATE message and sends the UPDATE message to the communication terminal device 20A as a destination (step ST14). In the UPDATE message, band information indicating the changed band is contained in the message. For example, when the booked band is 15 Mbps, if, for example, 7.5 Mbps is assigned to the communication between the multipoint control unit 30 and the communication terminal device 20A and the communication between the multipoint control unit 30 and the communication terminal device 20B, respectively, in the UPDATE message, 7.5 Mbps as the changed band is described as the band information.

The NGN network 40 transfers the UPDATE message supplied from the multipoint control unit 30 to the communication terminal device 20A (step ST15).

The communication terminal device 20A confirms that the band for the communication between the multipoint control unit 30 and the communication terminal device 20A changes to 7.5 Mbps based on the received UPDATE message, make settings of the respective parts so that the communication may be made in the changed band, and sends a 200 OK message as a response (step ST16). When the UPDATE message is not acceptable, the device sends a 488 Not Acceptable Here message as a response.

The NGN network 40 transfers the 200 OK message supplied from the communication terminal device 20A to the multipoint control unit 30 (step ST17).

In this manner, when the UPDATE message for changing the band is sent from the multipoint control unit 30 to the communication terminal device 20A, and the 200 OK message is sent from the communication terminal device 20A as a response, the communication between the multipoint control unit 30 and the communication terminal device 20A is made with the band changed from 15 Mbps to 7.5 Mbps (step ST18).

Thus, the multipoint control unit 30 changes the band for the communication with the communication terminal device 20A to 7.5 Mbps, and thereby, becomes able to assign the band of 7.5 Mbps to the communication with the communication terminal device 20B. Therefore, in order to make communication using a broadband line, the multipoint control unit 30 sends an INVITE message to the communication terminal device 20B as a destination (step ST19). In the INVITE message, the assignable band is described in the band information. For example, 7.5 Mbps is described in the band information of the INVITE message.

The NGN network 40 transfers the INVITE message supplied from the multipoint control unit 30 to the communication terminal device 20B (step ST20).

The communication terminal device 20B sends a 200 OK message as a response when the device can accept the received INVITE message (step ST21). Further, the communication terminal device 20B accepts the received INVITE message and stores the IP address of the multipoint control unit 30, the media type, the port number, the band information, etc. of video and sound and data contained in the INVITE message in a storage area provided for the multipoint control unit 30. When the INVITE message is not acceptable, the communication terminal device 20B sends a 488 Not Acceptable Here message as a response, for example.

The NGN network 40 transfers the 200 OK message supplied from the communication terminal device 20B to the multipoint control unit 30 (step ST22).

The multipoint control unit 30 establishes a session with the communication terminal device 20B in response to the supply of the 200 OK message from the communication terminal device 20B, and makes communication with the communication terminal device 20B using the assigned band of 7.5 Mbps (step ST23).

In this manner, even when the participant in the conference is added, the band can be automatically assigned to the added participant, and thereby, the disadvantage in the related art that it is hard to hold the conference with the additional participant can be solved. Further, during the conference, the communication can be made using the entire booked band, and thus, the band can be effectively used for the communication because it is not necessary to assign the band to a participant before the participant is added.

In the operation shown in FIG. 4, when a request of a session for communication over the booked band is made to the multipoint control unit 30, a response message that the request is not acceptable is sent from the NGN network 40. Further, in this case, the communication terminal device makes a request for participation in the conference to the multipoint control unit 30 using the narrow-band line. However, when the request of a session for communication over the booked band is passed by the SIP server and supplied to the multipoint control unit 30, the participation in the conference can be enabled without using the narrow-band line.

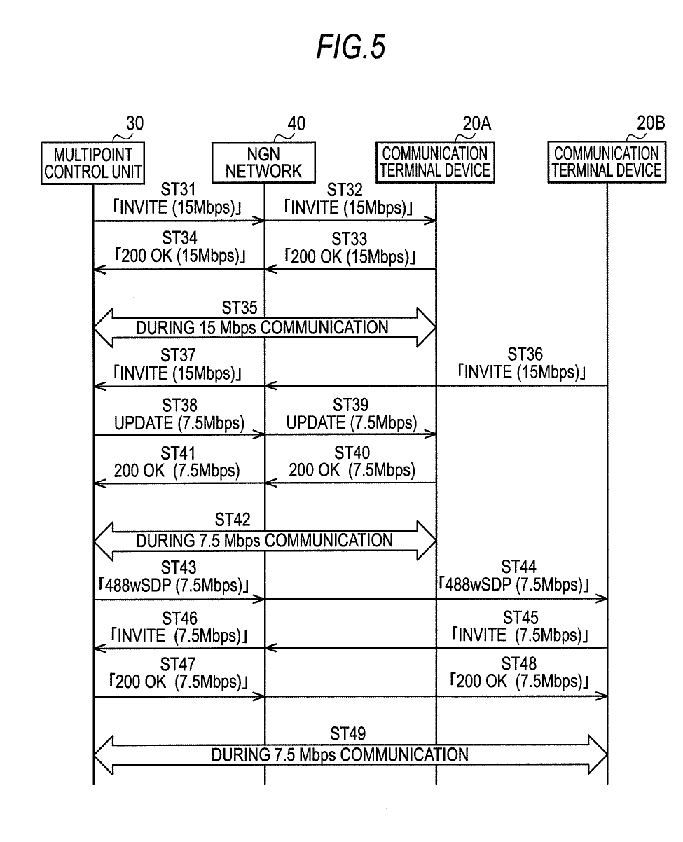

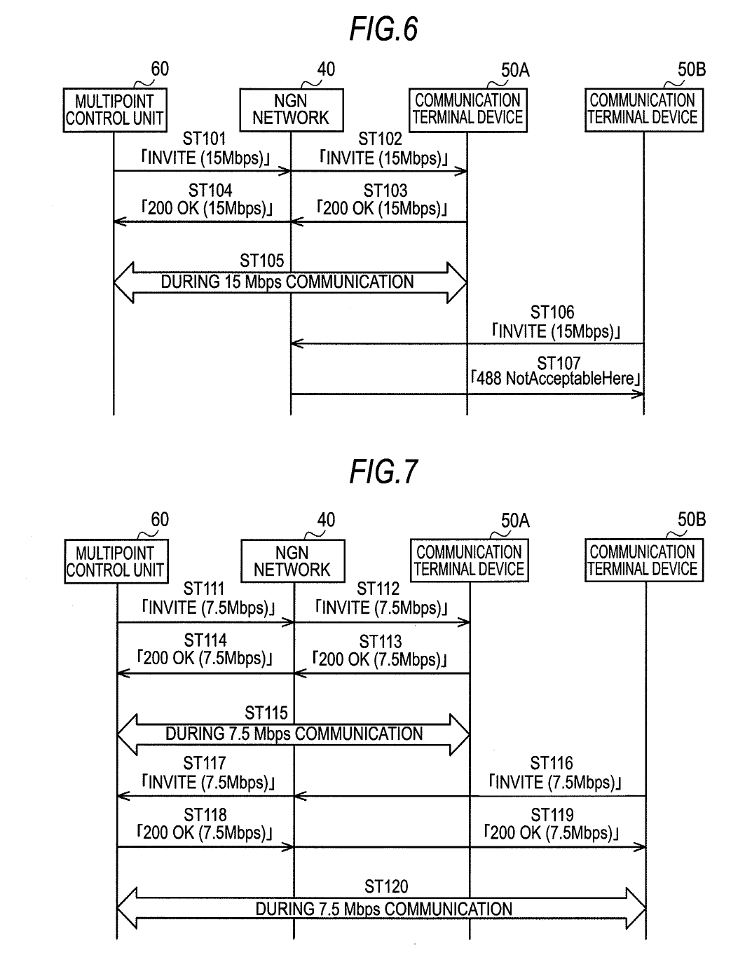

FIG. 5 is a sequence diagram showing the case where the request of a session for communication over the booked band is passed by the SIP server and supplied to the multipoint control unit 30.

The multipoint control unit 30 sends an INVITE message to the communication terminal device 20A as a destination (step ST31) to establish a session with the communication terminal device 20A as a participant of an electronic conference for holding the electronic conference. Here, when the booked band of the NGN network 40 is 15 Mbps as described above and the communication is made only between the multipoint control unit 30 and the communication terminal device 20A, the multipoint control unit 30 describes the booked band, i.e., 15 Mbps in the band information of the INVITE message for effective utilization of the band.

The NGN network 40 transfers the INVITE message supplied from the multipoint control unit 30 to the communication terminal device 20A (step ST32).

The communication terminal device 20A sends a 200 OK message as a response when the device can accept the received INVITE message (step ST33). Further, the communication terminal device 20A accepts the received INVITE message and stores the IP address of the multipoint control unit 30, the media type, the port number, the band information, etc. of video and sound and data contained in the INVITE message in a storage area provided for the multipoint control unit 30. When the INVITE message is not acceptable, the communication terminal device 20A sends a 488 Not Acceptable Here message as a response, for example.

The NGN network 40 transfers the 200 OK message supplied from the communication terminal device 20A to the multipoint control unit 30 (step ST34).

The multipoint control unit 30 establishes a session with the communication terminal device 20A in response to the supply of the 200 OK message from the communication terminal device 20A, and makes communication with the communication terminal device 20A using the booked band of 15 Mbps (step ST35).

Accordingly, the available band of the NGN network 40 can be effectively utilized in the electronic conference and communication of video and sound can be performed between the communication terminal device 20A and the multipoint control unit 30.

Then, when a new participant attends the electronic conference using the communication terminal device 20B, the communication terminal device 20B sends an INVITE message to the multipoint control unit 30 as a destination (step ST36). The unit describes the booked band, i.e., 15 Mbps in band information of the INVITE message when the booked band in the NGN network 40 is notified to the communication terminal device 20B.

The NGN network 40 transfers the INVITE message to the multipoint control unit 30 (step ST37) regardless whether the band described in the band information of the INVITE message supplied from the communication terminal device 20B can be assigned or not.

The multipoint control unit 30 determines whether participation in the conference is allowed or not based on the INVITE message supplied from the communication terminal device 20B. Here, when the participation in the conference is allowed, it is necessary to assign the band for communication with the communication terminal device 20B, and thus, in order to reduce the band assigned to the communication between the multipoint control unit 30 and the communication terminal device 20A, the multipoint control unit 30 generates an UPDATE message and sends the UPDATE message to the communication terminal device 20A as a destination (step ST38). In the UPDATE message, band information indicating the changed band is contained in the message. For example, when the booked band is 15 Mbps, for example, 7.5 Mbps is assigned to the communication between the multipoint control unit 30 and the communication terminal device 20A and the communication between the multipoint control unit 30 and the communication terminal device 20B, respectively, because the participants in the conference increase. Therefore, in the UPDATE message, 7.5 Mbps as the changed band is described as the band information. When the participation in the conference is not allowed, the multipoint control unit 30 sends a response message indicating that the INVITE message is not acceptable, e.g., a 488 Not Acceptable Here message as a response.

The NGN network 40 transfers the UPDATE message supplied from the multipoint control unit 30 to the communication terminal device 20A (step ST39).

The communication terminal device 20A confirms that the band for the communication between the multipoint control unit 30 and the communication terminal device 20A changes to 7.5 Mbps based on the received UPDATE message, make settings of the respective parts so that the communication is made in the changed band, and sends a 200 OK message as a response (step ST40). When the UPDATE message is not acceptable, the device sends a 488 Not Acceptable Here message as a response.

The NGN network 40 transfers the 200 OK message supplied from the communication terminal device 20A to the multipoint control unit 30 (step ST41).

In this manner, when the UPDATE message for changing the band is sent from the multipoint control unit 30 to the communication terminal device 20A, and the 200 OK message is sent from the communication terminal device 20A as a response, the communication between the multipoint control unit 30 and the communication terminal device 20A is made with the band changed from 15 Mbps to 7.5 Mbps (step ST42).

The multipoint control unit 30 changes the band for the communication with the communication terminal device 20A to 7.5 Mbps, and thereby, becomes able to assign the band of 7.5 Mbps to the communication with the communication terminal device 20B. Further, the multipoint control unit 30 is unable to make communication in the band described in the INVITE message supplied at step ST37, and sends a response message indicating that the INVITE message is not acceptable to the communication terminal device 20B. Furthermore, in order to make communication using a broadband line, the multipoint control unit 30 sends a response message formed by describing the assignable band in the message that the request is not acceptable. That is, the description that the band of 7.5 Mbps is assignable is provided in the message that the request is not acceptable, and the unit sends a 488 wSDP message in which the assignable description is provided as a response (step ST43).

The NGN network 40 transfers the 488 wSDP message supplied from the multipoint control unit 30 to the communication terminal device 20B (step ST44).

In order to enable communication in the band indicated by the 488 wSDP message, the communication terminal device 20B describes the band indicated by the 488 wSDP message in the band information of the INVITE message to the multipoint control unit 30 as a destination and sends it (step ST45).

The NGN network 40 transfers the INVITE message supplied from the communication terminal device 20B to the multipoint control unit 30 (step ST46).

The multipoint control unit 30 determines whether the received INVITE message is acceptable or not. Here, in the received INVITE message, the assignable band is described in the bond information, and accordingly, the unit sends a 200 OK message as a response to accept the INVITE message (step ST47). Further, the multipoint control unit 30 accepts the received INVITE message and stores the IP address of the communication terminal device 20B, the media type, the port number, the band information, etc. of video and sound and data contained in the INVITE message in a storage area provided for the communication terminal device 20B. In the case where the media type and the port number of video and sound and data are managed in the multipoint control unit 30, the media type and the port number may be described in the 488 wSDP message transmitted at step ST43 and the communication may be made using the media type and the port number described in the 488 wSDP message.

The NGN network 40 transfers the 200 OK message supplied from the multipoint control unit 30 to the communication terminal device 20B (step ST48).

The communication terminal device 20B establishes a session with the multipoint control unit 30 in response to the supply of the 200 OK message from the multipoint control unit 30, and makes communication with the multipoint control unit 30 using the assigned band of 7.5 Mbps (step ST49).

In this manner, the band can be automatically assigned to the added participant even without using the narrow-band line. Therefore, the disadvantage in the related art that it is hard to hold the conference with the additional participant can be solved. Further, during the conference, the communication can be made using the entire booked band, and thus, the band can be effectively used for the communication compared to the case where communication is made only in the band assigned to the participants in advance.

The above described embodiment is not limited to the case of holding a conference but also applied to the case of delivery of video contents or the like.

The embodiment of the invention enables communication by effectively utilizing the booked band even when the number of communication terminal devices for communication varies, and preferable for the case of holding an electronic conference via an NGN network or the like, for example.

The present application contains subject matter related to that disclosed in Japanese Priority Patent Application JP 2008-153784 filed in the Japan Patent Office on Jun. 12, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A communication control device comprising:
a network communication unit connected to plural communication terminal devices via a network that enables communication in a booked band for communication with the plural communication terminal devices; and
a control unit that, when a connection request is made from the communication terminal device but the band is not assignable, changes the band with the communication terminal device during communication to secure the band for communication with the communication terminal device that has made the connection request.

2. The communication control device according to claim 1, wherein, when the band is not assignable, the control unit sends a response indicating that the request is not acceptable to the connection request, and when the band for communication with the communication terminal device that has made the connection request is secured thereafter, the unit sends the connection request containing information indicating the secured band to the communication terminal device that has made the connection request.

3. The communication control device according to claim 1, wherein, when the band is not assignable, the control unit secures the band for communication with the communication terminal device that has made the connection request, and then, sends a response indicating that the request is not acceptable to the connection request containing information indicating the secured band.

4. A communication terminal device comprising:
a network communication unit connected to a communication control device via a network that enables communication in a booked band for communication with the communication control device; and
a control unit that, when a response that a request is not acceptable is issued to the connection request to the communication control device, makes a connection request to the communication control device using a transmission path of a narrower band than that in the network.

5. A communication system comprising:
a communication control device; and
plural communication terminal devices connected to the communication control device via a network that enables communication in a booked band,
wherein the communication control device includes a network communication unit that makes communication with the plural communication terminal devices via the network, and a control unit that, when a connection request is made from tile communication terminal device but the band is not assignable, changes the band with the communication terminal device during communication to secure the band for communication with the communication terminal device that has made the connection request, and
the communication terminal device includes a network communication unit that makes communication with the communication control device via the network, and a control unit that makes a connection request to the communication control device, and when a negative response is issued to the connection request, then makes communication with the communication control device using the secured band.

6. A communication control method comprising the steps of:
making communication with a communication terminal device connected via a network that enables communication in a booked band; and
when a connection request is made from another communication terminal device but the band is not assignable, changing the band with the communication terminal device during communication to secure the band for communication with the communication terminal device that has made the connection request.
